(19) United States
(12) Patent Application Publication
(10) Pub. No.: US 2012/0057138 A1
(43) Pub. Date: Mar. 8, 2012

(54) PROJECTION DISPLAY APPARATUS

(75) Inventors: Masahiro HARAGUCHI, Daito-City (JP); Masutaka Inoue, Hirakata-City (JP); Yoshinao Hiranuma, Hirakata-City (JP); Tomoya Terauchi, Daito-City (JP); Takaaki Abe, Osaka-City (JP); Noboru Yoshinobe, Hirakata-City (JP)

(73) Assignee: SANYO Electric Co., Ltd., Osaka (JP)

(21) Appl. No.: 13/222,695

(22) Filed: Aug. 31, 2011

(30) Foreign Application Priority Data
Aug. 31, 2010 (JP) 2010-195055

(51) Int. Cl. G03B 21/14

(52) U.S. Cl. 353/85

(57) ABSTRACT

A projection display apparatus according to a first feature includes: an imager that modulates light emitted from a light source; and a projection unit that projects the image light modulated by the imager onto a projection plane. The projection plane includes a projectable region where the image light can be projected. The projectable region includes a projection region on which the image light is projected based on an image signal and a non-projection region other than the projection region. The projection display apparatus further includes: an adjustment unit that adjusts the shape of the projection region within the projectable region; and a control unit that displays additional information at least in the non-projection region within the projectable region.

### CROSS REFERENCE TO RELATED APPLICATIONS

This application is based upon and claims the benefit of priority from prior Japanese Patent Application No. 2010-195055, filed on Aug. 31, 2010; the entire contents of which are incorporated herein by reference.

### BACKGROUND OF THE INVENTION

1. Field of the Invention

The present invention relates to a projection display apparatus including an imager that modulates light emitted from a light source and a projection unit that projects the light modulated by the imager onto a projection plane.

2. Description of the Related Art

Conventionally, there is known a projection display apparatus including an imager that modulates light emitted from a light source and a projection unit that projects the light modulated by the imager onto a projection plane.

In such a projection display apparatus, there is a need of displaying an image projected onto the projection plane and displaying additional information added to the image.

Examples of the additional information include information used for an interactive operation (e.g., menu information) and information used for a TV conference (e.g., information that can specify a participant himself or a partner participant).

In order to satisfy such a need, there is proposed a projection display apparatus that adds the additional information to within the image projected onto the projection plane (e.g., JP-A-2005-195661).

However, in the aforementioned projection display apparatus, the additional information is added to within the image projected onto the projection plane, and thus, the presence of the additional information prevents the visual confirmation of the image projected onto the projection plane.

### SUMMARY OF THE INVENTION

A projection display apparatus according to a first feature includes: an imager (liquid crystal panel 50) that modulates light emitted from a light source; and a projection unit (projection unit 110) that projects the image light modulated by the imager onto a projection plane. The projection plane includes a projectable region where the image light can be projected. The projectable region includes a projection region on which the image light is projected based on an image signal and a non-projection region other than the projection region. The projection display apparatus further includes: an adjustment unit (adjustment unit 280) that adjusts the shape of the projection region within the projectable region; and a control unit (element control unit 260) that displays additional information at least in the non-projection region within the projectable region.

A projection display apparatus according to a second feature includes: an imager (liquid crystal panel 50) that modulates light emitted from a light source; and a projection unit (projection unit 110) that projects the image light modulated by the imager onto a projection plane. The imager includes a displayable region in which the image light can be modulated. The displayable region includes an image region in which the image light is modulated based on an image signal and a non-image region other than the image region. The projection display apparatus further includes: an adjustment unit (adjustment unit 280) that adjusts the shape of the image region within the displayable region; and a control unit (element control unit 260) that displays additional information at least in the non-image region within the displayable region.

In the first feature or the second feature, the control unit switches modes between a display mode in which the additional information is displayed and a non-display mode in which the additional information is not displayed.

In the first feature or the second feature, the control unit switches the display mode and the non-display mode in response to a predetermined trigger.

In the first feature or the second feature, the control unit displays information used for a TV conference as the additional information, when the image projected on the projection plane is used for the TV conference.

In the first feature or the second feature, the control unit displays information used for an interactive operation as the additional information.

In the first feature or the second feature, the control unit displays assist information for changing a display location of the additional information.

### BRIEF DESCRIPTION OF THE DRAWINGS

FIG. 1 is a diagram illustrating an overview of a projection display apparatus 100 according to a first embodiment.

FIG. 2 is a diagram illustrating the configuration of the projection display apparatus 100 according to the first embodiment.

FIG. 3 is a block diagram illustrating a control unit 200 according to the first embodiment.

FIG. 4 is a diagram illustrating one example of a stored test pattern image according to the first embodiment.

FIG. 5 is a diagram illustrating one example of a stored test pattern image according to the first embodiment.

FIG. 6 is a diagram illustrating one example of a stored test pattern image according to the first embodiment.

FIG. 7 is a diagram illustrating one example of a stored test pattern image according to the first embodiment.

FIG. 8 is a diagram illustrating one example of a pickup test pattern image according to the first embodiment.

FIG. 9 is a diagram illustrating one example of a pickup test pattern image according to the first embodiment.

FIG. 10 is a diagram explaining a method of calculating an intersection included in a projected test pattern image according to the first embodiment.

FIG. 11 is a diagram for explaining a display of additional information according to the first embodiment.

FIG. 12 is a diagram for explaining a display of additional information according to the first embodiment.

FIG. 13 is a diagram illustrating one example of additional information according to the first embodiment.

FIG. 14 is a diagram illustrating one example of the additional information according to the first embodiment.

FIG. 15 is a diagram illustrating one example of the additional information according to the first embodiment.

FIG. 16 is a flowchart illustrating an operation of the projection display apparatus 100 according to the first embodiment.

### DETAILED DESCRIPTION OF THE EMBODIMENTS

Hereinafter, a projection display apparatus according to embodiments of the present invention is described with reference to drawings. In the following drawings, same or similar parts are denoted with same or similar reference numerals.

However, it should be noted that the drawings are merely exemplary and ratios of each dimension differ from the actual ones. Therefore, the specific dimensions, etc., should be determined in consideration of the following explanations. Moreover, it is needless to say that relations and ratios among the respective dimensions differ among the diagrams.

### Overview of Embodiments

A projection display apparatus according to an embodiment includes an imager that modulates light emitted from a light source and a projection unit that projects image light modulated by the imager onto a projection plane. The projection plane includes a projectable region in which the image light can be projected. The projectable region includes a projection region in which the image light is projected based on an image signal and a non-projection region other than the projection region. The imager includes a displayable region in which light can be modulated. The displayable region includes an image region in which light is modulated based on an image signal and a non-image region other than the image region.

A projection display apparatus according to a first characteristic includes an adjustment unit that adjusts the shape of the projection region, within the projectable region, and a control unit that displays the additional information to at least the non-projection region, within the projectable region.

A projection display apparatus according to a second characteristic includes an adjustment unit that adjusts the shape of the image region, within the displayable region, and a control unit that displays the additional information to at least the non-image region, within the displayable region.

According to the embodiment, the control unit displays the additional information in a region other than the image, within the projectable region (displayable region). Accordingly, it is possible to display the additional information, together with the image projected onto the projection plane, without preventing a visual confirmation of the image projected onto the projection plane.

### First Embodiment

### (Overview of Projection Display Apparatus)

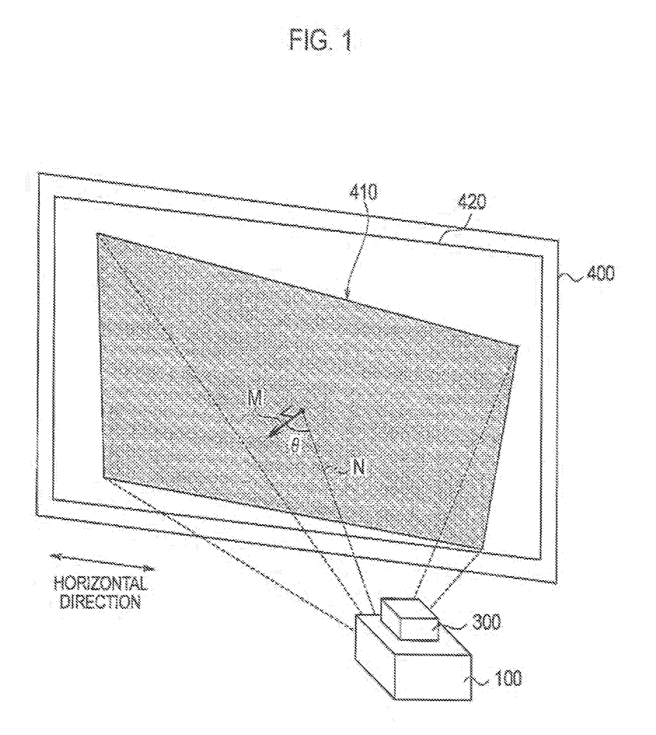

Hereinafter, the projection display apparatus according to the first embodiment is described with reference to drawings. FIG. 1 is a diagram illustrating an overview of the projection display apparatus 100 according to the first embodiment.

As illustrated in FIG. 1, in the projection display apparatus 100, an image pickup element 300 is arranged. The projection display apparatus 100 projects the image light onto the projection plane 400.

The image pickup element 300 picks up the projection plane 400. That is, the image pickup element 300 detects reflection light of the image light projected onto the projection plane 400 by the projection display apparatus 100. The image pickup element 300 outputs a pickup image along a predetermined line, to the projection display apparatus 100. The image pickup element 300 may be internally arranged in the projection display apparatus 100, or may be arranged together with the projection display apparatus 100.

The projection plane 400 is configured by a screen, for example. A region (projectable region 410) in which the projection display apparatus 100 can project the image light is formed on the projection plane 400. The projection plane 400 includes a display frame 420 configured by an outer frame of the screen.

The first embodiment illustrates a case where an optical axis N of the projection display apparatus 100 does not match a normal line M of the projection plane 400. For example, a case where the optical axis N and the normal line M configures an angle θ is illustrated.

That is, in the first embodiment, the optical axis N does not match the normal line M, and thus, the projectable region 410 (the image displayed on the projection plane 400) is distorted. In the first embodiment, a method of correcting the distortion of the projectable region 410 is mainly described.

### (Configuration of Projection Display Apparatus)

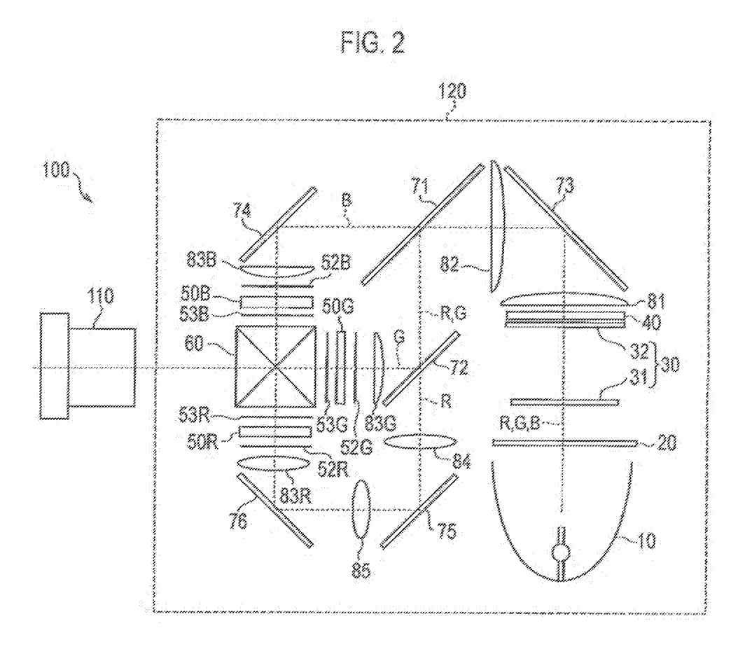

Hereinafter, the projection display apparatus according to the first embodiment is described with reference to drawings. FIG. 2 is a diagram illustrating the configuration of the projection display apparatus 100 according to the first embodiment.

As illustrated in FIG. 2, the projection display apparatus 100 includes a projection unit 110 and an illumination device 120.

The projection unit 110 projects the image light emitted from the illumination device 120, onto the projection plane (not illustrated), for example.

Firstly, the illumination device 120 includes a light source 10, a UV/IR cut filter 20, a fly eye lens unit 30, a PBS array 40, a plurality of liquid crystal panels 50 (a liquid crystal panel 50R, a liquid crystal pane) 50G, and a liquid crystal panel 50B), and a cross dichroic prism 60.

Examples of the light source 10 include those (e.g., a UHP lamp and a xenon lamp) which emits white light. That is, the white light emitted from the light source 10 includes red component light R, green component light G, and blue component light B.

The UV/IR cut filter 20 transmits visible light components (the red component light R, the green component light G, and the blue component light B). The UV/IR cut filter 20 blocks an infrared light component and an ultraviolet light component.

The fly eye lens unit 30 equalizes the light emitted from the light source 10. Specifically, the fly eye lens unit 30 is configured by a fly eye lens 31 and a fly eye lens 32. The fly eye lens 31 and the fly eye lens 32 are configured by a plurality of minute lenses, respectively. Each minute lens focuses light emitted by each light source 10 so that the entire surface of the liquid crystal panel 50 is irradiated with the light emitted by the light source 10.

The PBS array 40 makes a polarization state of the light emitted from the fly eye lens unit 30 uniform. For example, the PBS array 40 converts the light emitted from the fly eye lens unit 30 into an S-polarization (or a P-polarization).

The liquid crystal panel 50R modulates the red component light R based on a red output signal Rₒᵤₜ. At the side at which light is incident on the liquid crystal panel 50R, there is arranged an incidence-side polarization plate 52R that transmits light having one polarization direction (e.g., S-polarization) and blocks light having the other polarization direction (e.g., P-polarization). At the side at which light is emitted from the liquid crystal panel 50R, there is arranged an emission-side polarization plate 53R that blocks light having one polarization direction (e.g., S-polarization) and transmits light having the other polarization direction (e.g., P-polarization).

The liquid crystal panel 50G modulates the green component light G based on a green output signal Gₒᵤₜ. At the side at which light is incident on the liquid crystal panel 50G, there is arranged an incidence-side polarization plate 52G that transmits light having one polarization direction (e.g., S-polarization) and blocks light having the other polarization direction (e.g., P-polarization). On the other hand, at the side at which light is emitted from the liquid crystal panel 50G, there is arranged an emission-side polarization plate 53G that blocks light having one polarization direction (e.g., S-polarization) and transmits light having the other polarization direction (e.g., P-polarization).

The liquid crystal panel 50B modulates the blue component light B based on a blue output signal Bₒᵤₜ. At the side at which light is incident on the liquid crystal panel 50B, there is arranged an incidence-side polarization plate 52B that transmits light having one polarization direction (e.g., S-polarization) and blocks light having the other polarization direction (e.g., P-polarization). On the other hand, at the side at which light is emitted from the liquid crystal panel 50B, there is arranged an emission-side polarization plate 53B that blocks light having one polarization direction (e.g., S-polarization) and transmits light having the other polarization direction (e.g., P-polarization).

It is noted that the red output signal Rₒᵤₜ, the green output signal Bₒᵤₜ, and the blue output signal Bₒᵤₜ configure the image output signal. The image output signal is a signal to be output in a respective one of a plurality of pixels configuring one frame.

Here, a compensation plate (not illustrated) that improves a contrast ratio or a transmission ratio may be provided on each liquid crystal panels 50. In addition, each polarization plate may have a pre-polarization plate that reduces an amount of the light incident to the polarization plate or a thermal load.

The cross dichroic prism 60 configures a color combining unit that combines the light emitted from the liquid crystal panel 50R, the liquid crystal panel 50G, and the liquid crystal panel 50B. The combined light emitted from the cross dichroic prism 60 is guided to the projection unit 110.

Secondly, the illumination device 120 has a mirror group (mirror 71 to mirror 76) and a lens group (lens 81 to lens 85).

The mirror 71 is a dichroic mirror that transmits the blue component light B and reflects the red component light R and the green component light G. The mirror 72 is a dichroic mirror that transmits the red component light R and reflects the green component light G. The mirror 71 and the mirror 72 configure a color separation unit that separates the red component light R, the green component light G, and the blue component light B.

The mirror 73 reflects the red component light R, the green component light G, and the blue component light B and then guides the red component light R, the green component light G, and the blue component light B to the side of the mirror 71. The mirror 74 reflects the blue component light B and then guides the blue component light B to the side of the liquid crystal panel 50B. The mirror 75 and the mirror 76 reflect the red component light R and then guide the red component light R to the side of the liquid crystal panel 50R.

A lens 81 is a condenser lens that focuses the light emitted from the PBS array 40. A lens 82 is a condenser lens that focuses the light reflected by the mirror 73.

A lens 83R substantially collimates the red component light R so that the liquid crystal panel 50R is irradiated with the red component light R. A lens 83G substantially collimates the green component light G so that the liquid crystal panel 50G is irradiated with the green component light G. A lens 83B substantially collimates the blue component light B so that the liquid crystal panel 50B is irradiated with the blue component light B.

A lens 84 and a lens 85 are relay lenses that substantially form an image with the red component light R on the liquid crystal panel 50R while restraining expansion of the red component light R.

### (Configuration of Control Unit)

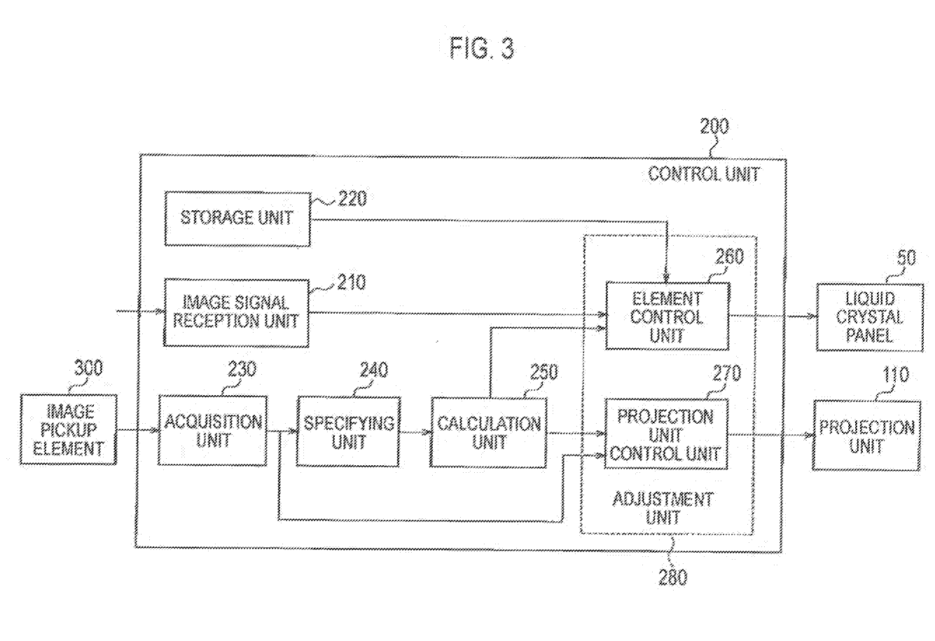

Hereinafter, the control unit according to the first embodiment is explained with reference to drawings. FIG. 3 is a block diagram illustrating a control unit 200 according to the first embodiment. The control unit 200 is arranged in the projection display apparatus 100 and controls the projection display apparatus 100.

The control unit 200 converts the image input signal into an image output signal. The image input signal is configured by a red input signal Rᵢₙ, a green input signal Gᵢₙ, and a blue input signal Bᵢₙ. The image output signal is configured by a red output signal Rₒᵤₜ, a green output signal Gₒᵤₜ, and a blue output signal Bₒᵤₜ. The image input signal and the image output signal are a signal to be input in a respective one of a plurality of pixels configuring one frame.

As illustrated in FIG. 3, the control unit 200 includes: an image signal reception unit 210; a storage unit 220; an acquisition unit 230; a specifying unit 240; a calculation unit 250; an element control unit 260; and a projection unit control unit 270.

The image signal reception unit 210 receives an image input signal from an external device (not illustrated) such as a DVD, a TV tuner, a mobile telephone, a personal computer, and an external storage device (e.g., a USB memory).

The storage unit 220 stores a variety of information. Specifically, the storage unit 220 stores: a frame detection pattern image employed to detect a display frame 420; a focus adjustment image employed to adjust a focus; and a test pattern image employed to calculate a positional relationship between the projection display apparatus 100 and the projection plane 400. Alternatively, the storage unit 220 may store an exposure adjustment image employed to adjust an exposure value. Moreover, the storage unit 220 stores additional information.

The test pattern image is an image configuring at least one portion of a respective one of three or more line segments configuring three or more intersections. In addition, the three or more line segments have a gradient relative to a predetermined line.

The image pickup element 300 outputs a pickup image along a predetermined line, as described above. The predetermined line is a pixel array in a horizontal direction, and the orientation of the predetermined line is in the horizontal direction, for example.

Hereinafter, one example of the test pattern image will be described with reference to FIG. 4 to FIG. 7. As illustrated in FIG. 4 to FIG. 7, the test pattern image is an image configuring at least one portion of four line segments (Lₛ1 to Lₛ4) configuring four intersections (Pₛ1 to Pₛ4). In the first embodiment, the four line segments (Lₛ1 to Lₛ4) are expressed by a difference (edge) in shading or brightness.

More specifically, as illustrated in FIG. 4, the test pattern image may be an open diamond with a black background. In this case, four sides of the open diamond configure at least one portion of the four line segments (Lₛ1 to Lₛ4). It is noted that the four line segments (Lₛ1 to Lₛ4) have a gradient relative to a predetermined line (horizontal direction).

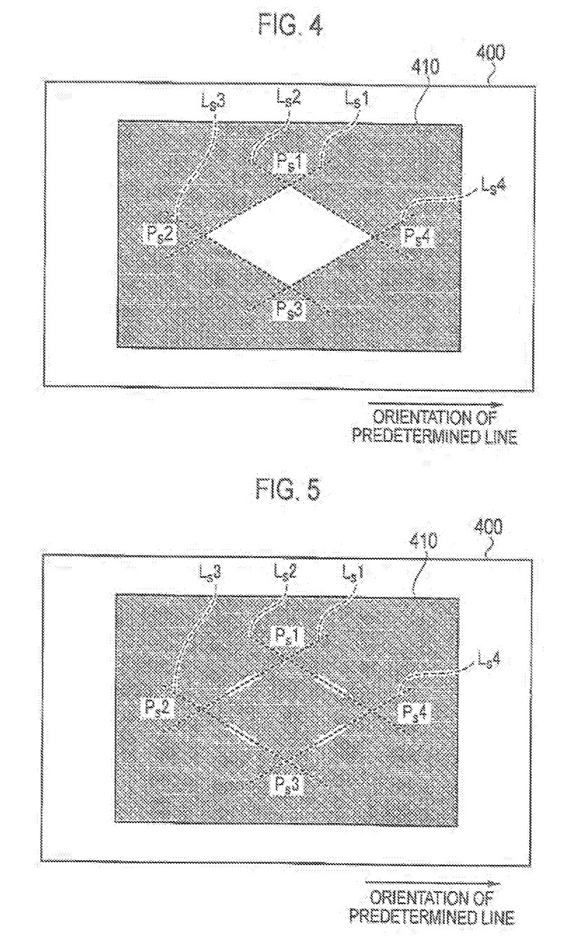

Alternately, as illustrated in FIG. 5, the test pattern image may be an open line segment with a black background. The open line segment configures one portion of the four sides of the open diamond illustrated in FIG. 4. In this case, the open line segment configures at least one portion of the four line segments (Lₛ1 to Lₛ4). It is noted that the four line segments (Lₛ1 to Lₛ4) have a gradient relative to a predetermined line (horizontal direction).

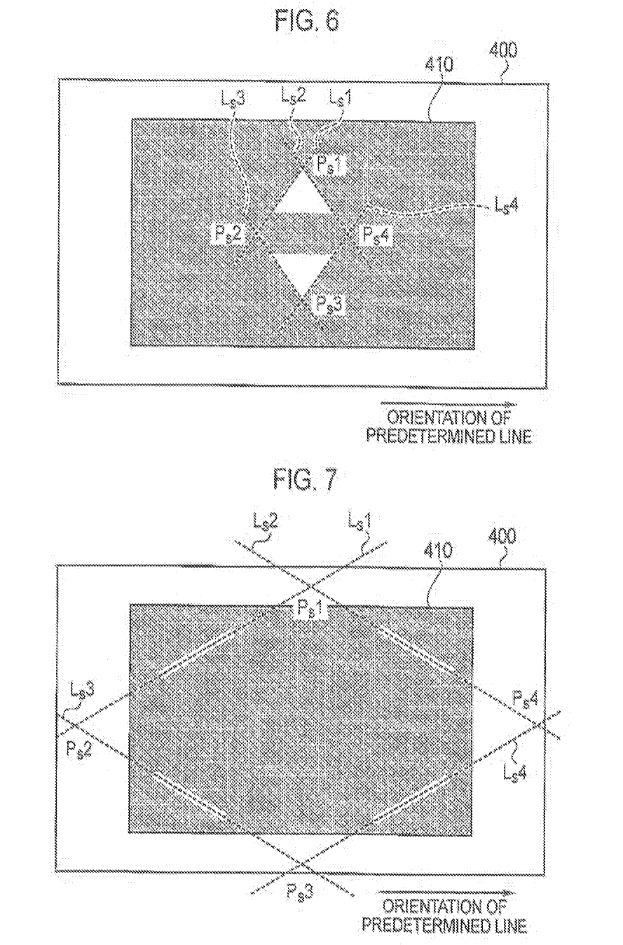

Alternately, as illustrated in FIG. 6, the test pattern image may be a pair of open triangles with a black background. In this case, two sides of the pair of open triangles configure at least one portion of the four line segments (Lₛ1 to Lₛ4). It is noted that the four line segments (Lₛ1 to Lₛ4) have a gradient relative to a predetermined line (horizontal direction).

Alternately, as illustrated in FIG. 7, the test pattern image may be an open line segment with a black background. In this case, the open line segment configures at least one portion of the four line segments (Lₛ1 to Lₛ4). As illustrated in FIG. 7, four intersections (Pₛ1 to Pₛ4) configured by four line segments (Lₛ1 to Lₛ4) may be arranged outside the projectable region 410. It is noted that the four line segments (Lₛ1 to Lₛ4) have a gradient relative to a predetermined line (horizontal direction).

The acquisition unit 230 acquires the pickup image output along a predetermined line from the image pickup element 300. For example, the acquisition unit 230 acquires a pickup image of the frame detection pattern image output along a predetermined line from the image pickup element 300. The acquisition unit 230 acquires the pickup image of a focus adjustment image output along a predetermined line from the image pickup element 300. The acquisition unit 230 acquires the pickup image of the test pattern image output along a predetermined line from the image pickup element 300. Alternately, the acquisition unit 230 may acquire a pickup image of the exposure adjustment image output along a predetermined line from the image pickup element 300.

The specifying unit 240 specifies three line segments included in the pickup image, based on the pickup image acquired for each predetermined line by the acquisition unit 230. Then, the specifying unit 240 acquires at least three intersections included in the pickup image, based on the three line segments included in the pickup image.

Specifically, the specifying unit 240 acquires at least three intersections included in the pickup image according to the following procedure. Herein, a case where the test pattern image is the image illustrated in FIG. 4 (open diamond) is illustrated.

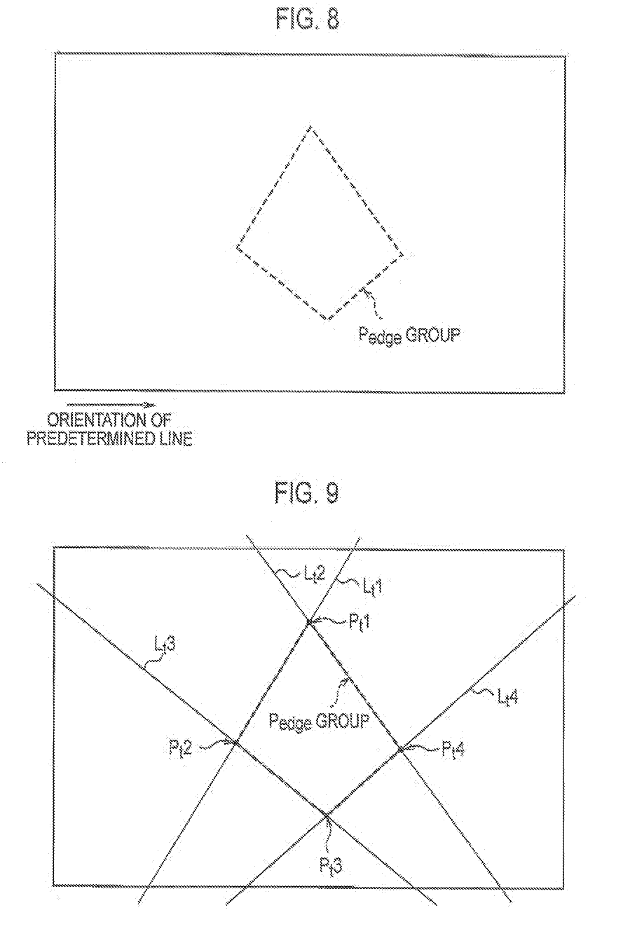

Firstly, the specifying unit 240 acquires a point group P_{edge} having a difference (edge) in shading or brightness, based on the pickup image acquired for each predetermined line by the acquisition unit 230, as illustrated in FIG. 8. That is, the specifying unit 240 specifies the point group P_{edge} corresponding to the four sides of the open diamond of the test pattern image.

Secondly, the specifying unit 240 specifies four line segments (Lₜ1 to Lₜ4) included in the pickup image, based on the point group P_{edge}, as illustrated in FIG. 9. That is, the specifying unit 240 specifies the four line segments (Lₜ1 to Lₜ4) corresponding to the four line segments (Lₛ1 to Lₛ4) included in the test pattern image.

Thirdly, the specifying unit 240 specifies four intersections (Pₜ1 to Pₜ4) included in the pickup image, based on the four line segments (Lₜ1 to Lₜ4), as illustrated in FIG. 9. That is, the specifying unit 240 specifies the four intersections (Pₜ1 to Pₜ4) corresponding to the four intersections (Pₛ1 to Pₛ4) included in the test pattern image.

The calculation unit 250 calculates a positional relationship between the projection display apparatus 100 and the projection plane 400, based on at least three intersections (Pₛ1 to Pₛ4, for example) included in the test pattern image and the three intersections (Pₜ1 to Pₜ4, for example) included in the pickup image. Specifically, the calculation unit 250 calculates a deviation amount between the optical axis N of the projection display apparatus 100 (projection unit 110) and the normal line M of the projection plane 400.

It is noted that hereinafter, the test pattern image stored in the storage unit 220 is referred to as “stored test pattern image”. The test pattern image included in the pickup image is referred to as “pickup test pattern image”. The test pattern image projected onto the projection plane 400 is referred to as “projected test pattern image”.

Firstly, the calculation unit 250 calculates coordinates of the four intersections (Pᵤ1 to Pᵤ4) included in the projected test pattern image. In this case, the intersection Pₛ1 of the stored test pattern image, the intersection Pₜ1 of the pickup test pattern image, and the intersection Pᵤ1 of the projected test pattern image are described as an example. The intersection Pₛ1, the intersection Pₜ1, and the intersection Pᵤ1 correspond to one another.

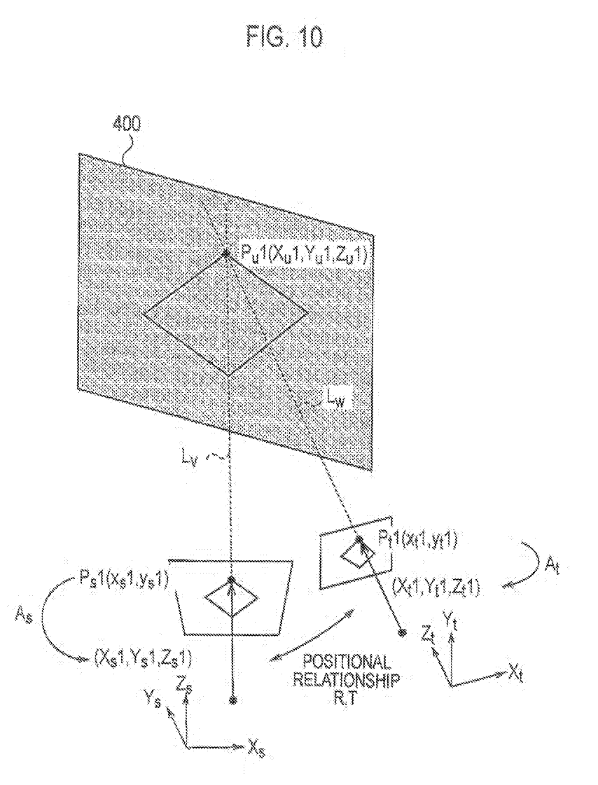

Hereinafter, a method of calculating coordinates (Xᵤ1, Yᵤ1, Zᵤ1) at the intersection Pᵤ1 will be described with reference to FIG. 10. It should be noted that the coordinates (Xᵤ1, Yᵤ1, Zᵤ1) at the intersection Pᵤ1 are coordinates in a three-dimensional space where a focal point Oₛ of the projection display apparatus 100 is the origin.

(1) The calculation unit 250 converts coordinates (xₛ1, yₛ1) at the intersection Pₛ1 in a two-dimensional plane of the stored test pattern image into the coordinates (Xₛ1, Yₛ1, Zₛ1) at the intersection Pₛ1 in the three-dimensional space where the focal point Oₛ of the projection display apparatus 100 is the origin. Specifically, the coordinates (Xₛ1, Yₛ1, Zₛ1) at the intersection Pₛ1 are expressed by the following equation.

$$( \begin{matrix}{X}_{s} 1 \\ {Y}_{s} 1 \\ {Z}_{s} 1\end{matrix} ) = As ( \begin{matrix}{x}_{s} 1 \\ {y}_{s} 1 \\ 1\end{matrix} ) \qquad Equation ( 1 )$$

It is noted that “As” denotes a 3×3 transformation matrix and can be acquire beforehand by a pre-process such as a calibration. That is, “As” is a known parameter.

In this case, a plane vertical to an optical axis direction of the projection display apparatus 100 is expressed by an Xₛ aids and a Yₛ axis, and the optical axis direction of the projection display apparatus 100 is expressed by a Zₛ aids.

Similarly, the calculation unit 250 coverts coordinates (xₜ1, yₜ1) at the intersection Pₜ1 in a two-dimensional plane of the pickup test pattern image into the coordinates (Xₜ1, Yₜ1, Zₜ1) at the intersection Pₜ1 in the three-dimensional space where a focal point Oₜ of the image pickup element 300 is the origin. This is expressed by the following equation.

$$( \begin{matrix}{X}_{t} 1 \\ {Y}_{t} 1 \\ {Z}_{t} 1\end{matrix} ) = At ( \begin{matrix}{x}_{t} 1 \\ {y}_{t} 1 \\ 1\end{matrix} ) \qquad Equation ( 2 )$$

It is noted that “At” denotes a 3×3 transformation matrix and can be acquire beforehand by a pre-process such as a calibration. That is, “At” is a known parameter.

In this case, a plane vertical to an optical axis direction of the image pickup element 300 is expressed by an Xₜ axis and a Yₜ axis, and the orientation of the image pickup element 300 (image pickup direction) is expressed by a Zₜ axis. It should be noted that in such a coordinate space, a gradient (vector) of the orientation of the image pickup element 300 (image pickup direction) is known.

(2) The calculation unit 250 calculates an equation of a straight line Lᵥ linking the intersection Pₛ1 and the intersection Pᵤ1. Similarly, the calculation unit 250 calculates an equation of a straight line L_{w} linking the intersection Pₜ1 and the intersection Pᵤ1. It is noted that the equations of the straight line Lᵥ and the straight line L_{w} are expressed as follows:

$$\begin{matrix}{L}_{v} = ( \begin{matrix}{x}_{s} \\ {y}_{s} \\ {z}_{s}\end{matrix} ) = {K}_{s} ( \begin{matrix}{X}_{s} 1 \\ {Y}_{s} 1 \\ {Z}_{s} 1\end{matrix} ) & Equation ( 3 ) \\ {L}_{w} = ( \begin{matrix}{x}_{t} \\ {y}_{t} \\ {z}_{t}\end{matrix} ) = {K}_{t} ( \begin{matrix}{X}_{t} 1 \\ {Y}_{t} 1 \\ {Z}_{t} 1\end{matrix} ) & Equation ( 4 )\end{matrix}$$

It is noted that Kₛ and Kₜ are intervening variables.

(3) The calculation unit 250 converts the straight line L_{w} into a straight line L_{w}′ in the three-dimensional space where the focal point Oₛ of the projection display apparatus 100 is the origin. The straight line L_{w}′ is expressed by the following equation:

$${L}_{w}^{′} = ( \begin{matrix}{x}_{t}^{′} \\ {y}_{t}^{′} \\ {z}_{t}^{′}\end{matrix} ) = {K}_{t} R ( \begin{matrix}{X}_{t} 1 \\ {Y}_{t} 1 \\ {Z}_{t} 1\end{matrix} ) + T \qquad Equation ( 5 )$$

It is noted that the optical axis of the projection display apparatus 100 and the orientation (image pickup direction) of the image pickup element 300 are known, and thus, a parameter R indicating a rotation component is known. Similarly, a relative position of the projection display apparatus 100 and the image pickup element 300 is known, and thus, a parameter T indicating a translation component also is known.

(4) The calculation unit 250 calculates the intervening variables Kₛ and Kₜ at the intersection (i.e., the intersection Pᵤ1) between the straight line Lᵥ and the straight line L_{w}′, based on the Equation (3) and the Equation (5). Then, the calculation unit 250 calculates the coordinates (Xᵤ1, Yᵤ1, Zᵤ1) at the intersection Pᵤ1, based on the coordinates (Xₛ1, Yₛ1, Zₛ1) at the intersection Pₛ1 and Kₛ. Alternately, the calculation unit 250 calculates the coordinates (Xᵤ1, Yᵤ1, Zᵤ1) at the intersection (Pᵤ1), based on the coordinates (Xₜ1, Yₜ1, Zₜ1) at the intersection Pₜ1 and Kₜ.

This enables the calculation unit 250 to calculate the coordinates (Xᵤ1, Yᵤ1, Zᵤ1) at the intersection Pᵤ1. Similarly, the calculation unit 250 calculates the coordinates (Xᵤ2, Yᵤ2, Zᵤ2) at the intersection Pᵤ2, the coordinates (Xᵤ3, Yᵤ3, Zᵤ3) at the intersection Pᵤ3, and the coordinates (Xᵤ4, Yᵤ4, Zᵤ4) at the intersection Pᵤ4.

Secondly, the calculation unit 250 calculates a vector of the normal line M of the projection plane 400. Specifically, the calculation unit 250 calculates the vector of the normal line M of the projection plane 400 by using the coordinates at three intersections or more, of the intersection Pᵤ1 to intersection Pᵤ4. The equation for the projection plane 400 is expressed by the following equation, and parameters k₁, k₂, and k₃ express the vector of the normal line M of the projection plane 400.

k₁x+k₂y+k₃z+k₄=0 Equation (6)

It is noted that k₁, k₂, k₃, and k₄ are predetermined coefficients.

This enables the calculation unit 250 to can be calculate a deviation amount between the optical axis N of the projection display apparatus 100 and the normal line M of the projection plane 400. That is, the calculation unit 250 is capable of calculating the positional relationship between the projection display apparatus 100 and the projection plane 400.

It is noted that in the first embodiment, the specifying unit 240 and the calculation unit 250 are separately described; however, the specifying unit 240 and the calculation unit 250 may be considered as a single configuration. For example, the calculation unit 250 may include the function of the specifying unit 240.

Returning to FIG. 3, the element control unit 260 converts the image input signal into the image output signal, and controls the liquid crystal panel 50 based on the image output signal. The element control unit 260 includes functions described below.

Specifically, the element control unit 260 includes a function of automatically correcting the shape of an image projected onto the projection plane 400, based on the positional relationship between the projection display apparatus 100 and the projection plane 400 (shape adjustment). That is, the element control unit 260 includes a function of automatically performing a trapezoidal correction based on the positional relationship between the projection display apparatus 100 and the projection plane 400.

Alternately, the element control unit 260 adjusts the zoom of an image projected onto the projection plane based on the positional relationship between the projection display apparatus 100 and the projection plane 400 (zoom adjustment).

The projection unit control unit 270 controls the lens group arranged in the projection unit 110. For example, the projection unit control unit 270 adjusts the focus of an image projected onto the projection plane 400 by the shift of the lens group arranged in the projection unit 110 (focus adjustment). The projection unit control unit 270 may adjust the zoom of an image projected onto the projection plane 400 by the shift of the lens group.

It is noted that the element control unit 260 and the projection unit control unit 270 configure the adjustment unit 280 that adjusts an image projected onto the projection plane 400.

### (Display of Additional Information)

Hereinafter, display of the additional information according to the first embodiment is described with reference to drawings. In the first embodiment, the aforementioned element control unit 260 controls the liquid crystal panel 50 in order to display additional information on the liquid crystal panel 50.

Firstly, the element control unit 260 adjusts the shape of an image displayed on the liquid crystal panel 50 within a displayable region 56 in which the image can be displayed by the liquid crystal panel 50 (shape adjustment). Secondly, the element control unit 260 displays the additional information in a region other than the image displayed on the liquid crystal panel 50. In this way, the element control unit 260 displays the additional information by using the region generated along with the shape adjustment.

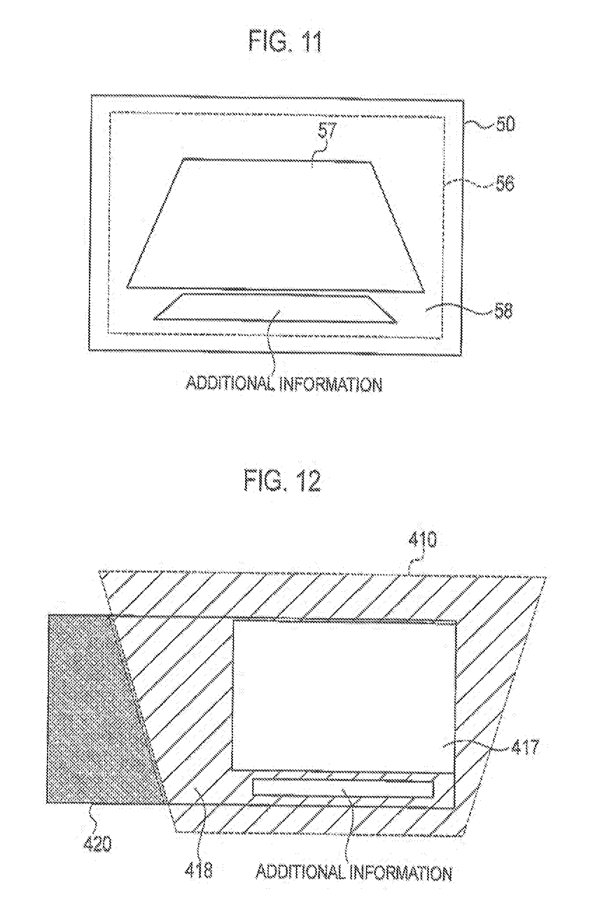

Specifically, as illustrated in FIG. 11, the liquid crystal panel 50 includes the displayable region 56, an image region 57, and a non-image region 58. The displayable region 56 is a region configured by a plurality of pixels and a region in which the liquid crystal panel 50 can modulate the image light. The image region 57 is a region in which the image light is modulated based on the image signal. The image region 57 is a region used for actually displaying the image after the shape adjustment. The non-image region 58 is a region other than the image region 57, of the displayable region 56.

In this case, the element control unit 260 displays the additional information in the non-image region 58 other than the image region 57, after the shape correction.

On the other hand, as seen from the projection plane 400, the projectable region 410 includes a projection region 417 and a non-projection region 418. The projectable region 410 is a region in which the image light emitted from the displayable region 56 can be projected. The projection region 417 is a region in which the image light is projected based on the image signal. The projection region 417 is a region in which the light emitted from the image region 57 is projected, and a region used for actually displaying the image. The non-projection region 418 is a region in which the light emitted from the non-image region 58 is projected, and a region other than the projection region 417, of the projectable region 410.

In this way, the element control unit 260 displays the additional information that should be added to the image displayed in the projection region 417, in the non-projection region 418 other than the projection region 417, by displaying the additional information in the non-image region 58.

It is noted that the additional information preferably is displayed in a region overlapping the display frame 420, of the non-projection region 418. In such a case, the element control unit 260 displays the additional information in one portion of the non-image region 58, based on a detection result of the display frame 420.

### (One Example of Additional Information)

Hereinafter, one example of the additional information according to the first embodiment is described with reference to drawings. It is noted that one example of the additional information will be described in view of the projection plane 400, below.

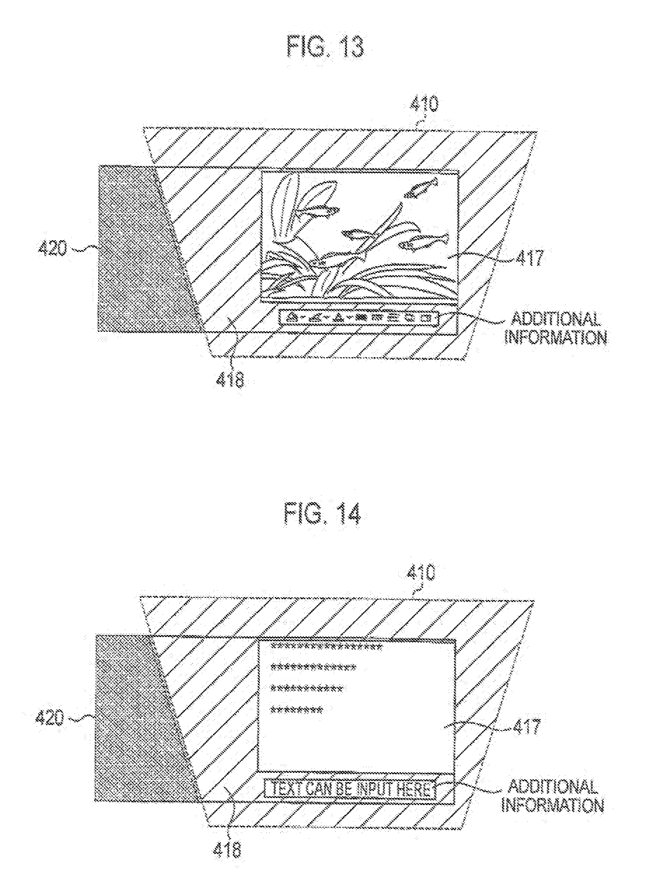

As illustrated in FIG. 13, the element control unit 260 displays information used for an interactive operation (e.g., a drawing tool bar) as the additional information. That is, the additional information (e.g., a drawing tool bar) is displayed in the non-projection region 418 other than the projection region 417.

In such a case, the element control unit 260 may switch modes between a display mode in which the additional information is displayed and a non-display mode in which the additional information is not displayed. For example, the element control unit 260 may display the additional information by switching the modes from the non-display mode to the display mode when it is detected that a user approaches the projection plane 400.

As illustrated in FIG. 14, the element control unit 260 displays information (e.g., a text string of “text can be input here”) for guiding a region in which text, as the additional information, can be input. That is, the additional information (e.g., a text string of “text can be input here”) is displayed in the non-projection region 418 other than the projection region 417.

In such a case, the element control unit 260 may switch modes between a display mode in which the additional information is displayed and a non-display mode in which the additional information is not displayed. For example, the element control unit 260 may display the additional information by switching the modes from the non-display mode to the display mode when it is detected that a user approaches the projection plane 400.

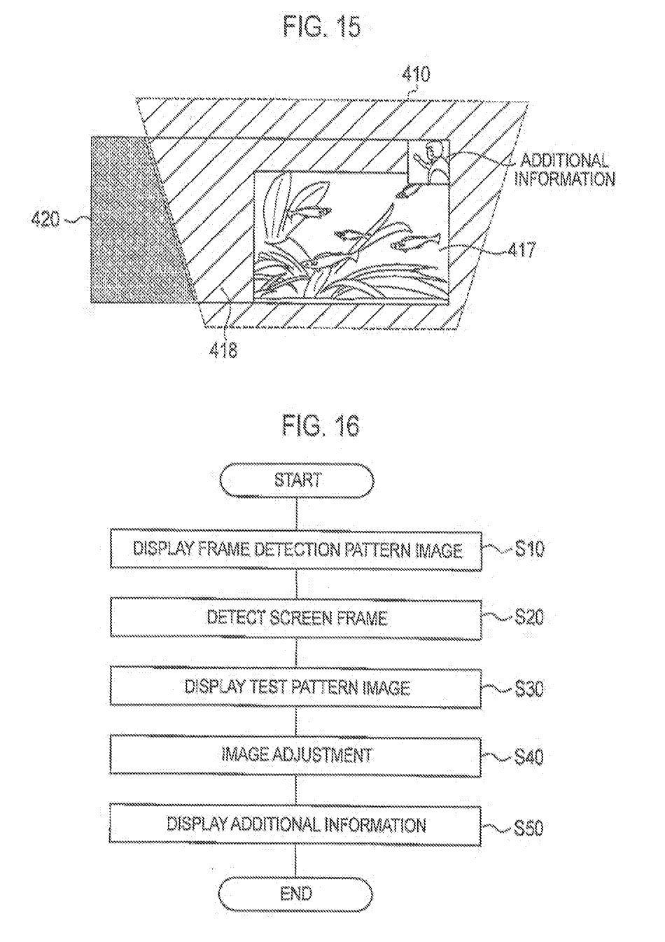

As illustrated in FIG. 15, the element control unit 260 displays information (e.g., an image of the user or an image of a partner) used for a television conference as the additional information, when the image projected onto the projection region 417 is used for a television, conference. That is, the additional information (e.g., an image of the user or an image of a partner) is displayed in the non-projection region 418 other than the projection region 417.

In such a case, the element control unit 260 may switch modes between a display mode in which the additional information is displayed and a non-display mode in which the additional information is not displayed. For example, the element control unit 260 may display the additional information by switching the modes from the non-display mode to the display mode, in response to the user operation.

### (Operation of Projection Display Apparatus)

Hereinafter, the operation of the projection display apparatus (control unit) according to the first embodiment is described with reference to drawings. FIG. 16 is a flowchart illustrating the operation of the projection display apparatus 100 (control unit 200) according to the first embodiment.

As illustrated in FIG. 16, in step 10, the projection display apparatus 100 displays (projects) the frame detection pattern image onto the projection plane 400. The frame detection pattern image is a white image, for example.

In step 20, the image pickup element 300 provided in the projection display apparatus 100 images the projection plane 400. That is, the image pickup element 300 images the frame detection pattern image projected onto the projection plane 400. Then, the projection display apparatus 100 detects a display frame 420 arranged on the projection plane 400 based on the pickup image of the frame detection pattern image.

In step 30, the projection display apparatus 100 displays (projects) the test pattern image onto the projection plane 400. The test pattern image is an open diamond with a black background, for example.

In step 40, the projection display apparatus 100 adjusts the shape of the image projected onto the projection plane 400 (shape adjustment) based on the positional relationship between the projection display apparatus 100 and the projection plane 400.

In step 50, the projection display apparatus 100 displays the image in the image region 57 and displays the additional information in the non-image region 58 other than the image region 57. As a result, the image is displayed in the projection region 417 and the additional information is displayed in the non-projection region 418 other than the projection region 417.

### (Operation and Effect)

In the first embodiment, the element control unit 260 displays the additional information in the non-projection region 418 (non-image region 58) other than the projection region 417 (image region 57), within the projectable region 410 (displayable region 56). Accordingly, it is possible to display the additional information, together with the image projected onto the projection plane 400, without preventing a visual confirmation of the image projected onto the projection plane 400.

### Other Embodiments

The present invention is explained through the above embodiment, but it must not be assumed that this invention is limited by the statements and drawings constituting a part of this disclosure. From this disclosure, various alternative embodiments, examples and operational technologies will become apparent to those skilled in the art.

In the aforementioned embodiment, the white light source is illustrated as an example of the light source. However, the light source may include LED (Light Emitting Diode), EL (Electro Luminescence), and LD (Laser Diode).

In the aforementioned embodiment, the transmissive liquid crystal panel is illustrated as an example of the imager. However, the imager may be a reflective liquid crystal panel and DMD (Digital Micromirror Device).

Although no specific description is provided in the aforementioned embodiment, the element control unit 260 preferably controls the liquid crystal panel 50 not to display the image from the display frame 420 is detected until the test pattern image is displayed.

Although no specific description is provided in the aforementioned embodiment, the element control unit 260 preferably controls the liquid crystal panel 50 not to display the image from at least three intersections included in the pickup test pattern image are acquired until the shape of the image projected onto the projection plane 400 is corrected.

Although no specific description is provided in the aforementioned embodiment, the element control unit 260 may display assist information for changing a display location of the additional information. Examples of the assist information include information indicating a location where, the additional information can be displayed and information indicating a direction in which the additional information can be moved.

Although no specific description is provided in the aforementioned embodiment, the element control unit 260 may switch between the display mode and the non-display Mode in response to a predetermined trigger. Examples of the trigger include: that in which it is detected that a user approaches the projection plane 400; that in which the adjustment of the shape of the image projected onto the projection plane 400 is completed; that in which the interactive operation is detected; that in which the operation of a remote controller, the operation of the projection display apparatus 100, and the arrangement of the projection display apparatus 100 remain unchanged for a predetermined time period; and that in which images projected onto the projection plane 400 have been switched (e.g., slides of a presentation material image have been changed).

Examples of the additional information may include various types of menu information items, a sub screen, a thumbnail, a subtitle, a previous slide of a presentation material image, operation instruction information of the projection display apparatus 100, a voice recognition result, alarm information of the projection display apparatus 100, a data broadcast, a news, date information, a calendar, and a viewing time of the image. The additional information may be displayed in a region including one portion of the image region 57 (projection region 417), as illustrated in FIG. 15.

When the image projected onto the projection plane 400 is utilized as the additional information, the image signal reception unit 210 may transmit a necessary image signal to the storage unit 220. The storage unit 220 stores the image signal transmitted from the image signal reception unit 210. For example, when a thumbnail is displayed, the image signal reception unit 210 transmits an image signal necessary for displaying the thumbnail to the storage unit 220. The storage unit 220 stores the image signal necessary for displaying the thumbnail.

The control unit 200 may further include an image signal reception unit that acquires an image utilized for the additional information, in addition to the image signal reception unit 210. At this time, the image signal reception unit arranged separately of the image signal reception unit 210 transmits the image signal necessary for displaying the additional information to the storage unit 220.

In the aforementioned embodiment, in the non-projection region 418, the additional information is displayed in a single location. Alternately, in the non-projection region 418, the additional information items are collectively displayed in a single location, as illustrated in FIG. 13. However, the embodiment is not limited thereto. For example, in the non-projection region 418, the additional information items may be displayed in a plurality of separate locations.

1. A projection display apparatus, comprising:
an imager that modulates light emitted from a light source; and
a projection unit that projects the image light modulated by the imager onto a projection plane, wherein
the projection plane includes a projectable region where the image light can be projected,
the projectable region includes a projection region on which the image light is projected based on an image signal and a non-projection region other than the projection region,
the projection display apparatus further comprising:
an adjustment unit that adjusts the shape of the projection region within the projectable region; and
a control unit that displays additional information at least in the non-projection region within the projectable region.

2. A projection display apparatus, comprising:
an imager that modulates light emitted from a light source; and
a projection unit that projects the image light modulated by the imager onto a projection plane, wherein
the imager includes a displayable region in which the image light can be modulated, and
the displayable region includes an image region in which the image light is modulated based on an image signal and a non-image region other than the image region,
the projection display apparatus further comprising:
an adjustment unit that adjusts the shape of the image region within the displayable region; and
a control unit that displays additional information at least in the non-image region within the displayable region.

3. The projection display apparatus according to claim 1, wherein the control unit switches modes between a display mode in which the additional information is displayed and a non-display mode in which the additional information is not displayed.

4. The projection display apparatus according to claim 1, wherein the control unit switches the display mode and the non-display mode in response to a predetermined trigger.

5. The projection display apparatus according to claim 2, wherein the control unit switches modes between a display mode in which the additional information is displayed and a non-display mode in which the additional information is not displayed.

6. The projection display apparatus according to claim 2, wherein the control unit switches the display mode and the non-display mode in response to a predetermined trigger.
